(19) United States
(12) Patent Application Publication
(10) Pub. No.: US 2026/0323306 A1
(43) Pub. Date: Oct. 15, 2026

(54) DYNAMIC SPECTRUM SHARING WITH A NON-TERRESTRIAL NETWORK

(71) Applicant: Google LLC, Mountain View, CA (US)

(72) Inventors: Jibing Wang, San Jose, CA (US); Erik Stauffer, Sunnyvale, CA (US); Aamir Akram, San Jose, CA (US)

(21) Appl. No.: 19/483,835

(22) PCT Filed: Jun. 6, 2024
(86) PCT No.: PCT/US2024/032743

§ 371 Date: Nov. 12, 2025

Related U.S. Application Data
(60) Provisional application No. 63/506,640, filed on Jun. 7, 2023.

(51) Int. Cl. H04W 16/14; H04W 72/044; H04W 84/06

(52) U.S. Cl. CPC H04W 16/14; H04W 72/046; H04W 84/06

(57) ABSTRACT

This disclosure provides systems, methods, and apparatuses for managing communications within a first coverage area of a non-terrestrial network (NTN) node implementing a first radio access technology (RAT) when the first coverage area temporarily overlaps with a second coverage area of a terrestrial network (TN) base station implementing a second RAT. The NTN node and the TN base station can implement dynamic spectrum sharing (DSS) to dynamically allocate spectrum between the NTN node (of the first RAT) and the TN base station (of the second RAT) based, at least in part, on configuration information received from the TN base station and on the overlap between the first and second coverage areas.

### RELATED APPLICATION

This application claims the priority benefit of U.S. Provisional Patent Application Ser. No. 63/506,640, filed Jun. 7, 2023, and entitled “DYNAMIC SPECTRUM SHARING WITH A NON-TERRESTRIAL NETWORK” the contents of which is hereby incorporated by reference herein.

### TECHNICAL FIELD

Aspects of the present disclosure generally relate to wireless communication and some aspects relate to dynamic spectrum sharing with a non-terrestrial network (NTN).

### DESCRIPTION OF THE RELATED TECHNOLOGY

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Wireless communication systems are widely deployed to provide diverse types of access techniques and connectivity options. These systems may be capable of supporting communication with multiple users by sharing the available system resources (for example, time, frequency, and power). A wireless communication system may include one or more base stations (sometimes referred to as network entities or network access nodes), each simultaneously supporting communication for multiple communication devices. A mobile communication device may be referred to as user equipment (UE). Base stations and UEs may implement a variety of radio access technologies (RATs). Examples of different RATs may include fourth generation (4G) systems such as Long Term Evolution (LTE) systems, LTE-Advanced (LTE-A) systems, or LTE-A Pro systems, and fifth generation (5G) systems which may be referred to as New Radio (NR) systems or 5G NR systems.

Wireless communication standards continue to evolve. Recent developments in 5G technology include the use of non-terrestrial network (NTN) nodes for network access. For example, an NTN node may include a spaceborne vehicle (such as a satellite) or an airborne vehicle (such as an unmanned aircraft system (UAS)). A non-terrestrial network refers to a network, or segment of networks, using radio frequency (RF) resources on board a satellite or on an airborne platform.

### SUMMARY

The systems, methods, and devices of this disclosure each have several innovative aspects, no single one of which is solely responsible for the desirable attributes disclosed herein.

One aspect of this disclosure can be implemented as a method for wireless communication by a non-terrestrial network (NTN) node associated with a first radio access technology (RAT), the NTN node having a first coverage area. The method includes the NTN node receiving configuration information from a base station associated with a second RAT different from the first RAT, the base station having a second coverage area that overlaps, at a time period, with the first coverage area as the NTN node moves along a pre-defined path. The method further includes the NTN node communicating a dynamic spectrum sharing (DSS) configuration to a user equipment (UE), the DSS configuration based, at least in part, on the configuration information and an overlap between the first and second coverage areas and transmitting a downlink wireless communication to the UE based on the DSS configuration.

Another innovative aspect of the subject matter described in this disclosure can be implemented as a method for wireless communication by a base station associated with a second RAT. The methos includes the base station receiving, at the base station, from a ground station of an NTN node implementing a first RAT different from the second RAT, a request for configuration information associated with the second RAT; transmitting the configuration information to the ground station of the NTN node, the NTN node having a first coverage area that overlaps, at a time period, with a second coverage area of the base station as the NTN node moves along a pre-defined path; and receiving, from the ground station, first and second RAT spectrum sharing information based, at least in part, on the configuration information and the overlap between the first and second overage areas.

Another innovative aspect of the subject matter described in this disclosure can be implemented as an apparatus that includes a communication unit and a processing system configured to control the communication unit to implement any one of the above-referenced methods.

Details of one or more implementations of the subject matter described in this disclosure are set forth in the accompanying drawings and the description below. Other features, aspects, and advantages will become apparent from the description, the drawings, and the claims.

### BRIEF DESCRIPTION OF THE DRAWINGS

Like reference numbers and designations in the various drawings indicate like elements. Note that the relative dimensions of the figures may not be drawn to scale. To easily identify the discussion of any particular element or act, the most significant digit or digits in a reference number refer to the figure number in which that element is first introduced.

FIG. 1 shows a pictorial diagram conceptually illustrating an example of a wireless communication system having user equipment (UE), terrestrial network (TN) nodes, and non-terrestrial network (NTN) nodes.

FIG. 2 shows a pictorial diagram conceptually a variety of TN nodes and NTN nodes.

FIG. 3 is a pictorial diagram conceptually illustrating an example wireless communication system where 5G coverage from a non-stationary NTN node intersects with the coverage area of long-term evolution (LTE) base stations.

FIG. 4 shows a block diagram illustrating communication between a UE, an LTE base station, and an NTN node in an example wireless communication system.

FIG. 5 shows dynamic spectrum sharing (DSS) by the NTN node when sharing spectrum with a TN base station.

FIG. 6 shows messaging between the UE, the LTE base station, and the NTN node when sharing spectrum in a wireless communication system.

FIG. 7 shows an example of LTE configuration information.

FIG. 8 shows an example DSS configuration used in one example approach for transferring DSS configuration information to the UE.

FIG. 9 shows a flow chart illustrating an example technique used by an NTN node to share spectrum with an LTE base station.

FIG. 10 shows a flow chart illustrating an example technique used by an LTE base station to share spectrum with an NTN node.

FIG. 11 shows a block diagram of an example wireless communication apparatus.

### DETAILED DESCRIPTION

The following description is directed to certain implementations for the purpose of describing innovative aspects of this disclosure. However, a person having ordinary skill in the art will readily recognize that the teachings herein can be applied in a multitude of different ways. Some of the examples in this disclosure are based on wireless communication according to the 3^{rd} Generation Partnership Project (3GPP) wireless standards, such as the 4th generation (4G) Long Term Evolution (LTE) and 5^{th} generation (5G) New Radio (NR) standards. However, the described implementations can be implemented in any device, system, or network that is capable of transmitting and receiving radio frequency signals according to any of the wireless communication standards, including any of the Institute of Electrical and Electronics Engineers (IEEE) 802.11 or 802.16 wireless standards, or other known signals that are used to communicate within a wireless, cellular, or internet of things (IoT) network, such as a system utilizing 4G, 5G, 6th generation (6G), WiFi, or future radio technology.

A wireless communication system may include one or more radio access networks (RANs) that provide access for a UE to communicate with other nodes in the wireless communication system. A radio access network (RAN), sometimes also referred to as a radio network or an access network, may include network nodes (such as base stations (BSs)) that support communication for UE. The UE may include a wireless communication apparatus (sometimes referred to as a communication module, communication unit, wireless communication interface, communication chipset, or the like) configured to transmit or receive radio frequency (RF) transmissions to or from a network node of the RAN. Non-terrestrial network (NTN) nodes (including Satellite or High-Altitude Platform Systems (HAPS)) extend coverage of a cellular network, providing access to, for instance, emergency services when a UE lacks terrestrial network (TN) coverage.

Various network nodes (such as TN base stations and NTN nodes) may implement different radio access technologies (RATs). Examples of different RATs may include LTE (4G networks) and 5G NR (5G networks). 5G technology provides its users with enhanced experiences through faster data speeds, higher capacity, lower latency, and higher reliability than existing 4G networks. 5G technology is often deployed within existing 4G networks. To fully exploit 5G technology, frequency bands used by existing 4G networks often are shared with the new 5G technology. Thus, the network nodes may share a common frequency band and may share spectrum resources such that each RAT may utilize respective portions of the spectrum resources. For example, spectrum sharing may enable both LTE and 5G NR network elements to communicate concurrently within a portion of the frequency band.

Dynamic spectrum sharing (DSS) is an approach for spectrum sharing. DSS has proven to be of use in terrestrial networks that deploy both 4G and 5G base stations. Using DSS, 4G and 5G nodes can dynamically allocate time-frequency resources for various carriers in the frequency bands shared by the 4G and 5G nodes. In some example approaches, In one example, an LTE terrestrial base station (eNB) and a 5G NR terrestrial base station (gNB) may coordinate spectrum sharing using DSS information exchanged between the eNB and the gNB. DSS provides flexible resource management that reduces interference between 4G and 5G communications while balancing demand for resources from both networks. However, while terrestrial base stations are generally fixed in location, an NTN node may be non-stationary. In some instances, an NTN node may quickly traverse through a coverage area associated with a terrestrial base station.

This disclosure provides systems, methods, and apparatuses for managing communications by an NTN node when the coverage area of the NTN node temporarily overlaps with coverage by a base station of a different RAT. In an example approach, a 5G NR NTN node moves relative to a 4G LTE TN base station such that the 5G NR coverage area of the 5G NR NTN node intersects or overlaps with 4G LTE coverage area of the 4G LTE TN base station. The DSS technique dynamically allocates spectrum between the NTN node and the TN base station. The spectrum sharing can be configured ahead of time and then activated when the overlap exists between the two coverage areas. Such an approach allows the NTN node and the TN base station to share spectrum where coverage intersects while reducing interference between the NTN node and the TN base station. In one such example approach, a non-geostationary satellite having a first RAT (e.g., 5G NR) moves along a path that passes near a TN base station having a second RAT (e.g., 4G LTE) such that the coverage area of the satellite overlaps with coverage area of the TN base station. The DSS technique dynamically allocates spectrum between the satellite and the base station for a time when the two coverage areas overlap.

Implementations of the subject matter described in this disclosure can be implemented to realize one or more of the following potential advantages. An NTN node may mitigate interference with terrestrial base stations as the NTN node moves along a path such that the coverage area of the NTN node overlaps with the coverage areas of the terrestrial base stations. Furthermore, the NTN node can take advantage of spectrum sharing techniques to operate in regions where base stations exist. In some aspects, the NTN node can coordinate the DSS configurations of various beams based on when and where the beams will create coverage areas that overlap coverage areas of terrestrial base stations.

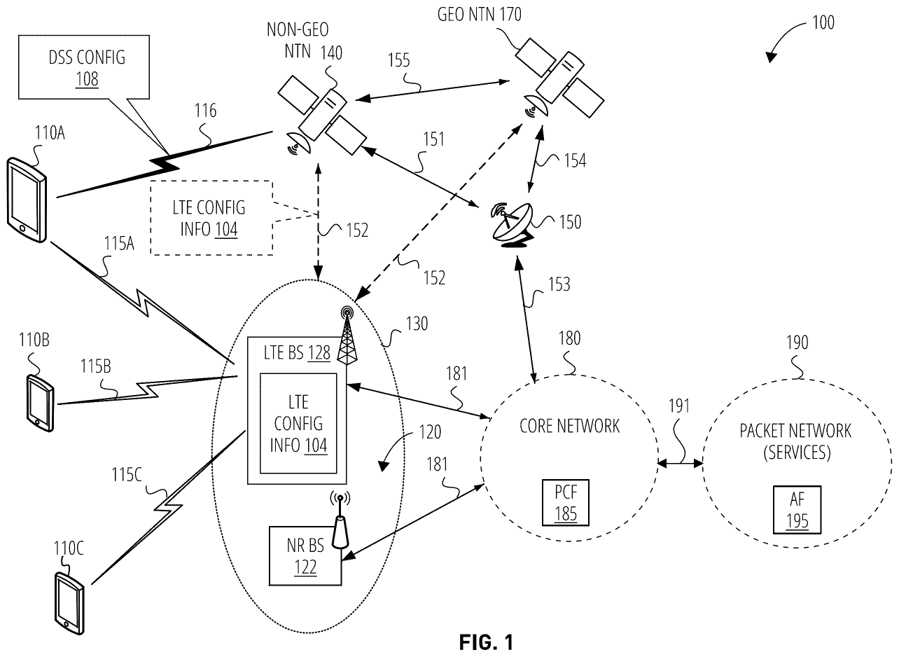

FIG. 1 shows a pictorial diagram conceptually illustrating an example of a wireless communication system having UE 110, TN nodes 120 and NTN nodes 140 and 170. The example wireless communication system 100 (which also may be referred to as a wireless communication network) includes one or more radio access networks (RANs) 130 that provide access for a UE 110 to communicate with other nodes in the wireless communication system 100. As shown in FIG. 1, the RAN 130 includes one or more TN nodes (shown as the TN nodes 120 and including the base stations (BSs) 122 and 128) that support communication for the UEs 110. Different types of base stations may be referred to as a NodeB, an LTE evolved NodeB (eNB), a next generation NodeB (gNB), an access point (AP), a radio head, a transmit-receive point (TRP), among other examples, depending on the wireless communication standard that the base station supports. One or more base stations (eNBs) may be deployed in an LTE RAN (or 4G RAN) and may be referred to as a 4G LTE network or 4G network. Similarly, one or more 5G base stations (gNBs) may be deployed in a 5G NR RAN and may be referred to as a 5G NR network or 5G network that provides access to the wireless communication system 100. The RAN 130 is an example of a radio access network that can be used to communicate to a core network 180 of the wireless communication system 100.

As shown in FIG. 1, the wireless communication system 100 includes the TN nodes 120 and other network entities. Each node of the TN nodes 120 provides communication coverage for a particular geographic area. In 3GPP, the term “cell” may refer to a coverage area of a BS, a BS subsystem serving this coverage area, or a combination thereof, depending on the context in which the term is used. Within each cell, the base station may operate at different frequencies for radio frequency communication between the UE 110 and the BS 122 or 128. In one example approach, a UE 110 communicates with a base station via a downlink (DL) and uplink (UL). The DL refers to the communication link from the BS to the UE and is sometimes referred to as the forward link. The UL refers to the communication link from the UE to the BS and is sometimes referred to as the reverse link.

A TN node may provide communication coverage for a macro cell, a pico cell, a femto cell, another type of cell, or a combination thereof. A macro cell may cover a relatively large geographic area (for example, several kilometers in radius) and may allow unrestricted access by UEs with service subscription. A pico cell may cover a relatively small geographic area and may allow unrestricted access by UEs with service subscription. A femto cell may cover a relatively small geographic area (for example, a home) and may allow restricted access by UEs having association with the femto cell (for example, UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, the BS 128 may be a macro-BS for a macro cell while BS 122 may be a femto BS for a femto cell. The BS 128 may support one or multiple (for example, three) cells.

The example, wireless communication system 100 may include a heterogeneous network that includes BSs of different types, for example, macro-BSs, pico BSs, femto BSs, relay BSs, among other examples. These distinct types of BSs may have different transmit power levels, different coverage areas, and different impacts on interference in wireless communication system 100. For example, macro-BSs may have a higher transmit power level (for example, 5 to 40 Watts) whereas pico BSs, femto BSs, and relay BSs may have a lower transmit power level (for example, 0.1 to 2 Watts).

In some examples, a network node may not necessarily be stationary, and the geographic area of the cell may move according to the movement of the network node. In some examples, base stations may be interconnected to one another as well as to one or more other BSs or network nodes in the wireless communication system 100 through various types of backhaul interfaces, such as Integrated Access and Backhaul (IAB), a direct physical connection, a virtual network, or a combination thereof using any suitable transport network. Furthermore, a network node may be a non-terrestrial network (NTN) node. FIG. 1 shows some example NTN nodes, including a geostationary NTN node 170 and a non-geostationary NTN node 140. Geosynchronous NTN nodes revolve around the planet at the same speed at which the planet rotates on its axis. Geosynchronous NTN nodes remain at the same longitude, although they may drift south or north depending on their orbit's inclination with Earth's equatorial plane. For this reason, a geosynchronous NTN node appears to be in the same region in the sky (at a given time of the day) when viewed from a particular position on Earth. Geostationary NTN nodes (such as the geostationary NTN node 170) are geosynchronous NTN nodes that remain stationary above the equator (i.e., no inclination). Non-geosynchronous NTN nodes revolve around the planet at a speed other than the speed at which the planet rotates on its axis. NTN nodes that are not geostationary may move relative to a TN base station, with areas of coverage that move into and out of the coverage area of the TN base station. For geosynchronous but not geostationary NTN nodes, movement of the NTN node relative to a TN base station is limited to north/south movement and is based on inclination. The example non-geostationary NTN node 140 may be an example of geosynchronous but not geostationary NTN node or an NTN node that is not geosynchronous.

In the example shown in FIG. 1, the UE 110A is in wireless communication 116 with the non-geostationary NTN node 140, while the UE 110A, 110B and 110C are in wireless communication 115 (115A, 115B and 115C) with the BS 128. The UEs 110 (for example, 110A, 110B, 110C) may be dispersed throughout wireless communication system 100, and each UE may be stationary or mobile. A UE also may be referred to as an access terminal, a terminal, a mobile station, a subscriber unit, or a station, among other examples. A UE may be a cellular phone (for example, a smart phone), a personal digital assistant (PDA), a wireless modem, a wireless communication device, a handheld device, a laptop computer, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (for example, smart ring, smart bracelet)), an entertainment device (for example, a music or video device, or a satellite radio), a vehicular component or sensor, smart meters/sensors, industrial manufacturing equipment, a global positioning system device, or any other suitable device that is configured to communicate via a wireless or wired medium.

Some UEs are machine-type communication (MTC) or evolved or enhanced machine-type communication (eMTC) UEs. MTC and eMTC UEs include, for example, robots, drones, remote devices, sensors, meters, monitors, location tags, among other examples, which can communicate with a base station, another device (for example, remote device), or some other entity. A UE may provide, for example, connectivity for or to a network (for example, a wide area network such as the Internet or a cellular network) via a wired or wireless communication link. Some UEs are Internet-of-Things (IoT) devices or may be implemented as narrowband internet of things (NB-IoT) devices. Some UEs are Customer Premises Equipment (CPE). The UE 110 may be included inside a housing that houses components of the UE 110, such as processor components, memory components, similar components, or a combination thereof.

Any number of RANs 130 may be deployed in a geographic area. Each RAN 130 may support a particular radio access technology (RAT) and may operate on one or more frequencies. A RAT also may be referred to as a radio technology, an air interface, among other examples. A frequency may also be referred to as a carrier, component carrier, a frequency channel, bandwidth part, among other examples.

In the example shown in FIG. 1, the NTN node 140 is a non-stationary NTN node in wireless communication 151 with the ground station 150 and, through the ground station 150, with the core network 180 (through wired or wireless communication 153). A geostationary NTN node 170 is geostationary and in wireless communication 154 with the ground station 150 (or another ground station) and, through the ground station 150, with the core network 180 (through wired or wireless communication 153). Furthermore, in some implementations, the geostationary NTN node 170 can be in communication 155 with the NTN node 140.

In one example, the BS 128 and the BS 122 are in wired or wireless communication 181 with the core network 180 and, in some approaches, in wireless communication 152 with the non-stationary NTN node 140 and the geostationary NTN node 170 as well. The core network 180 communicates with the packet network 190 through wired or wireless communications 191. In some example approaches, an Application Function (AF) 195 executing in packet network 190 interacts with a 3GPP core network 180 to provide services. In some such example approaches, a trusted AF 195 for Edge computing guides a Policy Control Function (PCF) 185 executing in the core network 180 in determination of UE Route Selection Policy (URSP) rules, so that the URSP configured on the UE 110 can consider the requirements of specific applications executing in the packet network 190.

In one example approach, a UE 110 performs a Public Land Mobile Number (PLMN) selection to select a PLMN for registration. In a conventional network selection mechanism, the UE 110 selects the PLMN and RAN based on priority before performing a cell selection based on cell-provided cell selection criteria. The UE limits cell selection to candidate cells that are in the selected PLMN and RAN. Cell selection or reselection may involve selection of a candidate cell that has the highest signal strength or signal quality that the UE 110 can measure from among the candidate cells in the selected PLMN/RAN. The UE may monitor signal strength and signal quality of multiple frequencies to select the serving cell from among the candidate cells in the selected PLMN. In some implementations, a UE may receive a system information block (SIB) message or other type of message that can be populated with the PLMN identifier (PLMN ID) and cell-provided cell selection criteria. The UE 110 may camp on a selected serving cell to register with the PLMN. The UE 110 can perform a tracking area registration, so that the wireless communication system knows which tracking area to page the UE for mobile-terminated communications. Additionally, the UE 110 can establish a radio resource control (RRC) connection with the serving cell to obtain configuration or other information about the wireless communication system. A UE 110 is considered to be camped on a serving cell when the UE has registered with the wireless communication and established a basic RRC relationship with the cell. The serving cell is available for mobile originated (MO) or mobile terminated (MT) communication between the UE 110 and the wireless communication system 100.

The non-stationary NTN node 140 may move into or out of an area where the BS 128 offers coverage. When the BS 128 is a base station that provides LTE coverage, the NTN node 140 may use DSS to temporarily share spectrum between the NTN node 140 and the BS 128, as detailed below. In one example approach, the NTN node 140 can use DSS to share spectrum with the BS 128, to avoid interfering with the BS 128 communications, or to reduce interference by the BS 128 with 5G communications by the NTN node 140. The NTN node 140 can adjust DSS settings based on NTN behavior (e.g., beam selection and NTN node movement relative to the BS 128).

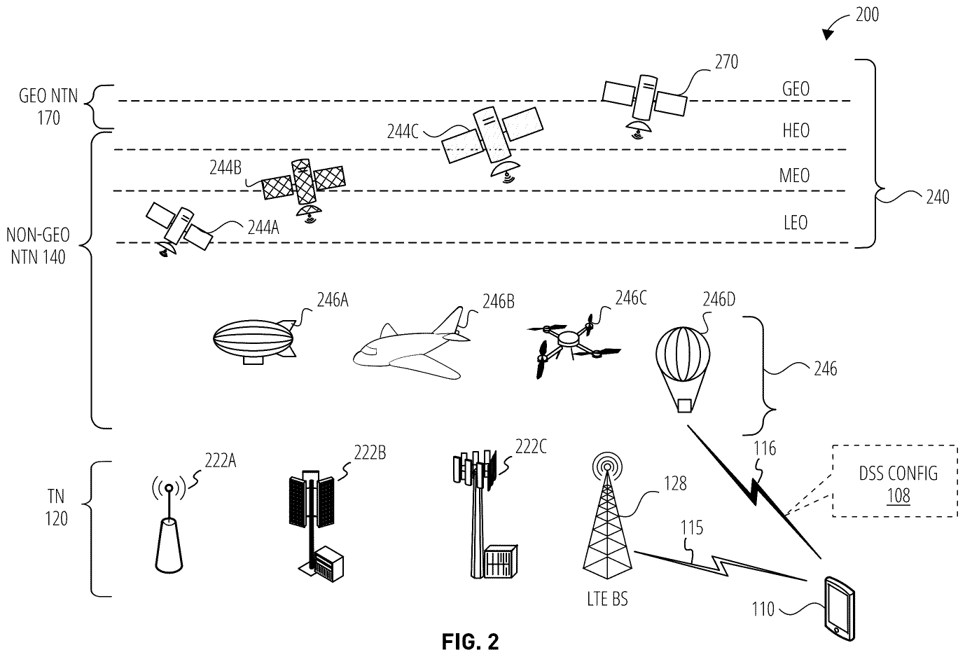

FIG. 2 shows a pictorial diagram 200 conceptually illustrating a variety of TN nodes and NTN nodes. In the example shown in FIG. 2, one or more of the TN nodes 120 may be connected through wireless communications 115 to the UE 110. Alternatively, or additionally, one or more of the NTN nodes 140 may be connected through wireless communications 116 to the UE 110. The TN nodes 120 in FIG. 2 include a femto or pico cell station 222A, a small cell base station 222B, a macro cell base station 222C, and a BS 128 that supports LTE communication with a UE 110.

Examples of NTN nodes include airborne platforms 246 and spaceborne platforms 240. Example airborne platforms 246 can include balloons 246D, dirigibles 246A, winged platforms such as airplane 246B and drones 246C, among other examples. Example spaceborne platforms 240 include a Low Earth Orbit (LEO) satellite 244A, a Medium Earth Orbit (MEO) satellite 244B, a Highly Elliptical Orbit (HEO) satellite 244C, and a geostationary satellite 270, among other examples. The geostationary satellite 270 is an example of a geostationary NTN node 170, while other ones of the example airborne platforms 246 and spaceborne platforms 240 are examples of a non-geostationary NTN node 140.

In one example approach, the balloon 246D communicates via 5G NR RAT with the UE 110 using one of more frequency bands of the BS 128 while the BS 128 communicates with the UE 110 (or other UEs) using 4G LTE RAT. In one such example approach, the balloon 246D provides DSS configuration information to the UE 110 when sharing spectrum with the BS 128.

In one example approach, the balloon 246D receives LTE configuration information associated with LTE communications of the BS 128 before the 5G coverage area of the balloon 246D begins to overlap with the LTE coverage area of the BS 128. Using the LTE configuration information and DSS, the balloon 246D and the BS 128 can share spectrum. DSS can reduce interference caused by the 5G signal of the balloon 246D with LTE communications and can reduce interference caused by the BS 128 with 5G communications. Such an approach also allows DSS-enabled communications between the balloon 246D and the UE 110 to begin as soon as the balloon 246D arrives in range of the UE 110. DSS-controlled 5G communications with the UE 110 continue for as long as the UE 110 remains in an intersection zone formed by the intersection of the coverage area of the balloon 246D and the coverage area of the BS 128.

According to aspects of this disclosure, any of the NTN nodes described with reference to FIG. 2 can implement DSS to share spectrum with one or more TN nodes 120 based on location and timing of the NTN node relative to the coverage area of one or more TN nodes 120. For instance, any of the NTN nodes 140 may be non-stationary and moving in a path that places the NTN node 140 in a location where interference could occur between the BS 128 and the NTN node 140 as the NTN node 140 passes by the BS 128. The NTN node 140 can implement DSS to mitigate such interference by sharing spectrum between the NTN node 140 and the BS 128, as explained in further detail below.

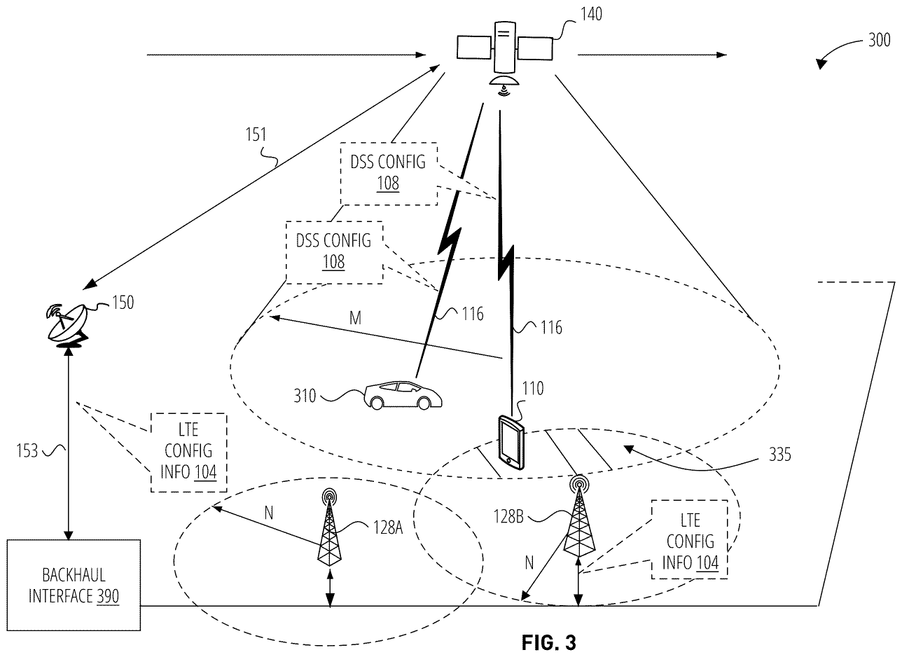

FIG. 3 is a pictorial diagram conceptually illustrating an example wireless communication system 300 where 5G coverage from a non-stationary NTN node 140 moving in the direction of the arrow intersects with the LTE coverage area of BSs 128A and 128B. In the example shown in FIG. 3, the BS 128A and 128B have cells with a radius of N, while the NTN node 140 has a cell with a radius of M, where M is greater than N.

In the example shown in FIG. 3, the NTN node 140 moving on a defined path begins to approach the coverage areas of the BSs 128A and 128B. At first, there is no interference between the LTE coverage area of the BSs 128A and 128B and the 5G coverage area of the NTN node 140. Accordingly, the NTN node 140 can, for instance, provide 5G coverage to the vehicle 310 while the BS 128B provides LTE coverage provided to the UE 110.

In the example shown in FIG. 3, as the NTN node 140 moves left to right along the designated path (or pre-defined path), 5G coverage area of the NTN node 140 begins to intersect with a portion of the LTE coverage area of the BS 128B, creating an intersection zone 335. The intersection creates a potential for interference between LTE coverage of the BS 128B and 5G coverage of the NTN node 140. In one example approach, the NTN node 140 uses DSS to address the potential interference by dynamically sharing the spectrum between the 5G network of the NTN node 140 and the LTE network of the BS 128B.

In contrast to TN implementations of DSS, in a non-stationary NTN implementation, interactions between network nodes are not static. Instead, an NTN node 140 will approach and then pass a BS 128. The NTN node 140 may implement DSS while coverage of the two different systems overlap to avoid problems caused by interference between the two different RATs. In one example approach, therefore, BS 128 and NTN node 140 may activate DSS operation mode when approaching coverage overlap in intersection zone 335, and may revert to a non-DSS operation mode once 5G coverage by the NTN node 140 no longer overlaps with LTE coverage by the BS 128B. If the NTN node 140 moves along a pre-defined path at a pre-defined rate, the time that the intersection begins, and ends can be determined. System 300 therefore acts to avoid interference by employing DSS preemptively between NTN node 140 and the BS 128B during the time the two coverage areas intersect or overlap.

In one example approach, the BS 128B transfers the LTE configuration information to NTN node 140 via wireless communication 152. In another example approach, the BS 128B transfers the LTE configuration information to NTN node 140 via ground station 150, or via another network element of wireless communication system 300.

In one example approach, the BS 128B transfers the LTE configuration information to NTN node 140 before the satellite coverage begins to interfere with the LTE coverage of the BS 128B. In one such example approach, the NTN node 140 then applies DSS to dynamically allocate spectrum (e.g., time-frequency resources) between NTN node 140 and the BS 128B such that the DSS configuration may be activated before the two coverage areas overlap.

In one example approach, the BS 128B and the NTN node 140 use the spectrum dynamically allocated by DSS to continue 5G NR communications with vehicle 310 and to maintain LTE coverage with the UE 110 in the interference zone. In another such example approach, the BS 128B and the NTN node 140 use the spectrum dynamically allocated by DSS to continue 5G NR communications with vehicle 310 and to initiate 5G NR coverage with the UE 110 in the interference zone. In yet another such example approach, the BS 128B and the NTN node 140 use the spectrum dynamically allocated by DSS to continue 5G NR communications with vehicle 310, to initiate 5G NR coverage with the UE 110 in the interference zone, and to continue LTE coverage with a 4G UE (not shown) in the interference zone, or elsewhere in the LTE coverage area.

When satellite coverage no longer overlaps with base station coverage, DSS is disabled and both the NTN node 140 and the BS 128B may take advantage of available spectrum for their respective RATs. In the example shown in FIG. 3, when the NTN node 140 moves further to the right, vehicle 310 may be handed over to another NR cell, as the NTN node 140 moves even further along its path, the UE 110 may return to LTE coverage.

In one example approach, as the 5G NR coverage area of the NTN node 140 approaches intersection zone 335, the NTN node 140 queries the BS 128B and receives LTE configuration information 104 from the BS 128B, as will be explained in detail below. The NTN node 140 determines a DSS configuration 108 that dynamically shares the spectrum of the BS 128B with the NTN node 140. The NTN node 140 also shares the DSS configuration 108 with any UE 110 that falls within intersection zone 335, or anywhere else in the coverage area of NTN node 140. In some such example approaches, the NTN node 140 includes a ground station 150. In one such example approach, ground station 150 is the one that queries the BS 128B, receives LTE configuration information 104 from the BS 128B, and determines the DSS configuration 108 that dynamically shares the spectrum of the BS 128B with the NTN node 140. Ground station 150 then shares the DSS configuration 108 with any UE 110 that falls within intersection zone 335, or anywhere else in the coverage area of NTN node 140.

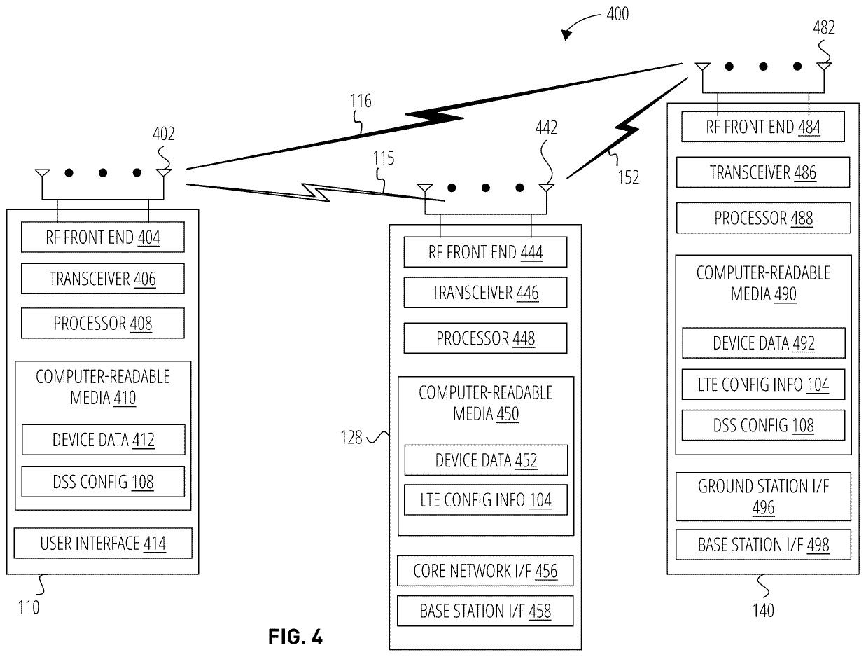

FIG. 4 shows a block diagram illustrating communication between a UE, an LTE base station and a non-stationary NTN node in an example wireless communication system. FIG. 4 illustrates an example wireless communication system 400 having UE 110, BS 128, and the non-stationary NTN node 140 that can implement DSS through BS 128 and the non-stationary NTN node 140. In some examples, UE 110, BS 128, and the NTN node 140 can include additional functions and interfaces that are omitted from FIG. 4 for the sake of clarity.

In the example shown in FIG. 4, the UE 110 includes antennas 402, a radio-frequency front end (shown as RF front end 404), a wireless transceiver 406, and a user interface 414. The wireless transceiver 406 may include a Ka-band or S-band interface for wireless communication 116 with the NTN node 140 and an LTE transceiver and/or a 5G NR transceiver for wireless communication 115 with BS 128. The antennas 402, the RF front end 404, and the wireless transceiver 406 can be used for communicating with the BS 128 and/or the NTN node 140. The RF front end 404 couples or connects the wireless transceiver 406 to the antennas 402. The antennas 402 can include an array of multiple antennas that are configured similar to or differently from each other. The antennas 402 and the RF front end 404 can be tuned to, and/or be tunable to, one or more frequency bands defined by the 3GPP LTE, 5G NR and NTN communication standards and implemented by the wireless transceiver 406. By way of example and not limitation, the antennas 402 and the RF front end 404 can be implemented for operation in sub-GHz bands, sub-6 Gigahertz (GHz) bands, and/or above 6 GHz bands (e.g., GHz bands associated with millimeter wavelengths or terahertz (THz) bands associated with submillimeter wavelengths). Additionally, the antennas 402, the RF front end 404, and the wireless transceiver 406 may be configured to support beamforming for wireless communication.

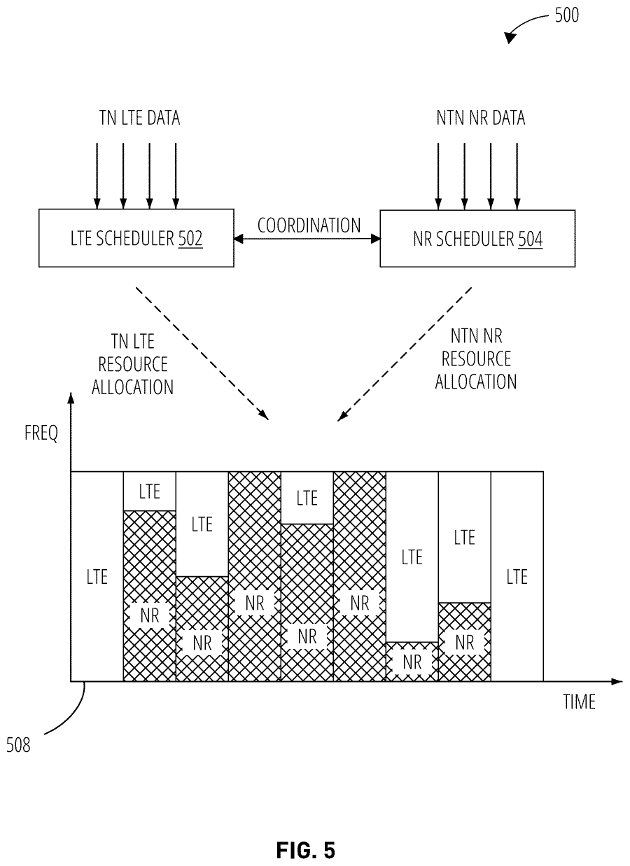

The UE 110 also includes at least one processor 408 and at least one computer-readable storage media or computer-readable media (CRM) 410. Processor 408 may be a single core processor, or a multiple core processor composed of a variety of materials, such as silicon, polysilicon, high-K dielectric, copper, and so on. The CRM 410 described herein excludes propagating signals and can include any suitable memory or storage device such as random-access memory (RAM), static RAM (SRAM), dynamic RAM (DRAM), non-volatile RAM (NVRAM), read-only memory (ROM), or Flash memory useable to store device data 412 of the UE 110. In some examples, the device data 412 includes user data, multimedia data, beamforming codebooks, applications, neural network (NN) tables, neural network training data, and/or an operating system of the UE 110, some of which are executable by processor(s) 408 to enable user-plane data, control-plane information, and user interaction with the UE 110. In some aspects, the CRM 410 includes one or more DSS configurations 108, as discussed further in FIG. 5-11.

The device diagram for the BS 128, shown in FIG. 4, includes a single 4G or 5G network node capable of operating in 4G LTE mode within one or more LTE bands. The functionality of the BS 128 may be distributed across multiple network nodes or devices and may be distributed in any fashion suitable to perform the functions described herein. BS 128 includes antennas 442, at least one radio-frequency front end (shown as RF front end 444), and one or more transceiver transceivers 446 (e.g., one or more LTE transceivers and/or one or more 5G NR transceivers). The antennas 442, the RF front end 444, and the wireless transceiver 446 can be used for communicating with the UE 110 and/or the NTN node 140. The RF front end 444 couples or connects the wireless transceiver 446 to the antennas 442. The antennas 442 can include an array of multiple antennas that are configured to be similar to, or different from, each other. The antennas 442 and the RF front end 444 can be tuned to, and/or be tunable to, one or more frequency bands defined by the 3GPP LTE, 5G NR, and 5G NTN communication standards and implemented by the wireless transceiver 446. By way of example and not limitation, the antennas 442 and the RF front end 444 can be implemented for operation in sub-GHz bands, sub-6 GHz bands, and/or above 6 GHz bands (e.g., GHz bands associated with millimeter wavelengths or terahertz (THz) bands associated with sub-millimeter wavelengths). Additionally, the antennas 442, the RF front end 444, and/or the wireless transceiver 446 can be configured to support beamforming, such as Massive-MIMO, for wireless communication.

The BS 128 also includes at least one processor 448 and at least one computer-readable storage media or computer-readable media (CRM) 450. The processor 448 may be a single core processor or a multiple core processor composed of a variety of materials, such as silicon, polysilicon, high-K dielectric, copper, and so on. CRM 450 may include any suitable memory or storage device such as random-access memory (RAM), static RAM (SRAM), dynamic RAM (DRAM), non-volatile RAM (NVRAM), read-only memory (ROM), or Flash memory usable to store device data 452 of the BS 128. The device data 452 includes network scheduling data, radio resource management data, beamforming codebooks, applications, and/or an operating system of the BS 128, which are executable by processor 448 to enable wireless communication with the UE 110. CRM 450 also includes one or more instances of LTE configuration information 104 that can be forwarded to non-stationary NTN node 140.

The BS 128 also includes a core network interface 456, which the BS 128 configures to exchange user-plane data, control-plane information, and/or other data/information with core network functions and/or entities. The BS 128 additionally includes an inter-base station interface 458, such as an Xn and/or X2 interface, which the BS 128 configures to exchange user-plane data, control-plane information, and/or other data/information between other base stations, to manage the communication of the BS 128 with the UE 110.

The device diagram for the non-stationary NTN node 140, shown in FIG. 4, includes a single network node (e.g., a single satellite). The functionality of the NTN node 140 may be distributed across multiple network nodes or devices or between the NTN node 140 and a ground station 150 and may be distributed in any fashion suitable to perform the functions described. The NTN node 140 includes antennas 482, at least one radio-frequency front end (shown as radio-frequency front end 484), and one or more wireless transceivers 486 (operating at e.g., the S-band or K-band and/or as an Xn and/or X2 interface). The antennas 482, the radio-frequency front end 484, and the wireless transceivers 486 can be used for communicating with the UE 110 and the BS 128. The radio-frequency front end 484 couples or connects the wireless wireless transceivers 486 to the antennas 482. The antennas 482 can include an array of multiple antennas that are configured to be similar to, or different from, each other. The antennas 482 and the radio-frequency front end 484 can be tuned to, and/or be tunable to, one or more frequency bands defined by the 3GPP NTN communication standards and implemented by the wireless transceivers 486.

The NTN node 140 also includes at least one processor 488 and at least one computer-readable storage media or computer-readable media (CRM) 490. The processor 488 may be a single core processor or a multiple core processor composed of a variety of materials, such as silicon, polysilicon, high-K dielectric, copper, and so on. CRM 490 may include any suitable memory or storage device such as random-access memory (RAM), static RAM (SRAM), dynamic RAM (DRAM), non-volatile RAM (NVRAM), read-only memory (ROM), or Flash memory usable to store device data 492 of the NTN node 140. The device data 492 includes network scheduling data, radio resource management data, beamforming codebooks, applications, and/or an operating system of the NTN node 140, which are executable by processor 488 to enable wireless communication with the UE 110 and the BS 128. CRM 490 also includes LTE configuration information 104 received from BS 128 and one or more versions of DSS configuration 108, each associated with an intersection zone.

The wireless transceivers 406, 446, and 486 are examples of a communication unit. The processors 408, 448, 488 can also be referred to as a processing system. Other examples of a communication unit and a processing system are possible, including some examples that are commonly used in a wireless communication system.

In one example approach, the NTN node 140 also includes a ground station interface 498 for communicating with a ground station 150 (such as shown in FIG. 1) and an inter-base station interface 496 to manage the communication of the NTN node 140 with BS 128.

Returning to FIGS. 1-3, prior to entering the coverage area of a first terrestrial base station (such as the BS 128B), the NTN node 140 obtains configuration information 104 of the BS 128B detailing LTE operation and traffic. In some examples, non-stationary NTN node 140 obtains the LTE configuration information directly from the BS 128B or indirectly via another network element (e.g., a geosynchronous satellite, a ground station 150, a backhaul interface 390, or some combination thereof).

In some example approaches, NTN node 140 obtains the LTE configuration information 104 via a message formatted to include the LTE configuration information. In one example approach, LTE configuration information 104 includes a representation of a Cell Reference Signal (CRS) configuration of the BS 128B. CRS is a cell-specific (or common) reference signal in LTE DL and is transmitted in every slot/subframe across the frequency band. The CRS serves an important role in LTE communication and may be avoided, in some examples, when allocating NR resources to prevent interfering with the CRS. In one example approach, LTE configuration information 104 further includes a Physical Downlink Control Channel (PDCCH) configuration of the BS 128B, a Multicast-Broadcast Single Frequency Network (MBSFN) configuration of the BS 128B, a Primary Synchronization Signal (PSS) configuration of the BS 128B, and a Secondary Synchronization Signal (SSS) configuration of the BS 128B, or any combination thereof.

In some implementations, the DSS configuration may be specific to a particular beam of the NTN node 140 or may be specific to one or more UEs 110 served by the NTN node. In one example approach, a beam of the NTN node refers to a transmission signal from the NTN node 140 that creates a coverage area at the Earth's surface. In some implementations, an NTN node 140 may operate multiple beams and may transmit a DSS configuration for each beam that intersects or overlaps with or will intersect or overlap with an LTE TN coverage area. In some implementations, the DSS configuration for a particular beam is based on the terrestrial base stations (such as BS 128) that have coverage areas overlapping the coverage area of that beam. In some implementations, the NTN node 140 may aggregate DSS information from the BS 128 and from one or more base stations 128 within the coverage area of a particular beam. In some example approaches, NTN node 140 uses beam steering (e.g., beamforming) to either avoid or decrease intersection with an LTE coverage area.

In the example above, the NTN node 140 determines and distributes the DSS configuration to the UE 110 and to BS 128 impacted by the DSS configuration. Although the discussion above indicates that the NTN node 140 determines the DSS configuration 108, in some examples, DSS software executes in any one or more of the NTN nodes 140, the BS 128, ground station 150, backhaul interface 390 or any of the other network elements of system 300 to determine the DSS configuration 108.

FIG. 5 shows DSS processing 500 by the non-stationary NTN node when sharing spectrum with a 4G LTE TN base station. In some implementations, DSS configuration 108 includes scheduling information for various subframes or slots (time) and frequency (freq)/resource blocks (RBs) within the shared spectrum 508. In one example DSS approach, an LTE scheduler 502 and a NR scheduler 504 coordinate with each other to exchange traffic status or resource sharing status as coverage intersection approaches and while coverage intersection exists. Schedulers 502 and 504 also dynamically assign available resources in a synchronized manner, increasing and decreasing LTE and NR resource allocation to match LTE demand and NR demand, respectively. Such an approach enables, for instance, dynamic resource allocation for instantaneous NR traffic bursts that may occur with the addition of UEs 110 to the 5G NR network in intersection zone 335 and elsewhere. In some example approaches, the NR signal/channel may be rate matched around LTE signals such as CRS, as explained in further detail below. In some such example approaches, selected resource elements (REs) are not used for NR transmission because they are, instead, reserved for CRS (which is transmitted in every subframe and across the entire frequency band).

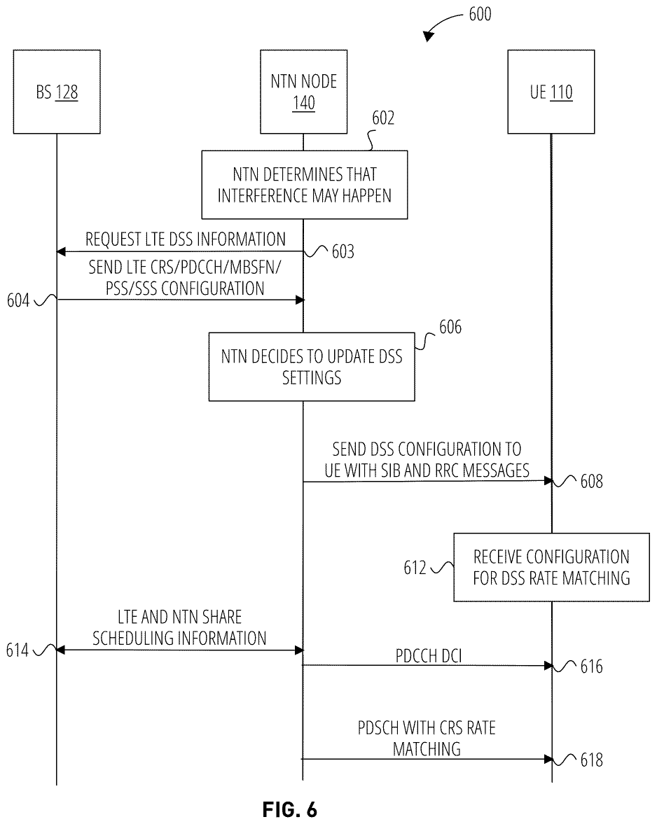

FIG. 6 shows messaging 600 between the UE, the LTE base station, and the non-stationary NTN node when sharing spectrum in the wireless communication systems of FIG. 3 and FIG. 4. As noted above, the NTN node 140 may communicate with future affected terrestrial BSs (such as BS 128) to request/receive TN BS configurations and to configure a UE receiving 5G NR communications via the NTN node 140. In one example approach, ground station 150 of the NTN node 140 coordinates with the BS 128 on scheduling and on DSS configuration fields through the Xn interface. In one such example approach, the BS 128 sends LTE configuration information 104 to ground station 150, although the DSS operation may occur at the NTN node 140 or other network entities. In some implementations, the terrestrial LTE base stations have priority to the available spectrum during the DSS operation. For example, the terrestrial LTE base stations may have less flexibility to adjust their settings, while the NTN node 140 may have greater flexibility. Accordingly, satellite NR NTN nodes and their connected NR UEs may adjust their spectrum utilization around the spectrum utilization of the terrestrial LTE base stations.

The disclosed techniques can be implemented with an NTN node that uses a transparent architecture (where the base station is on the ground). Alternatively, the disclosed techniques can be used with an NTN node that uses a regenerative architecture (where some base station components are at the NTN node. For example, the functions of one or both of a Distributed Unit (DU) or Centralized Unit (CU) can be performed by an NTN node that uses the regenerative architecture. In a 5G system, the DU typically manages physical layer transmission and some layer 2 scheduling, while the CU is responsible for some layer 2 features such as RRC messaging. In some 5G systems, the DU and CU are split such that some component may perform the DU features while another component performs the CU features.

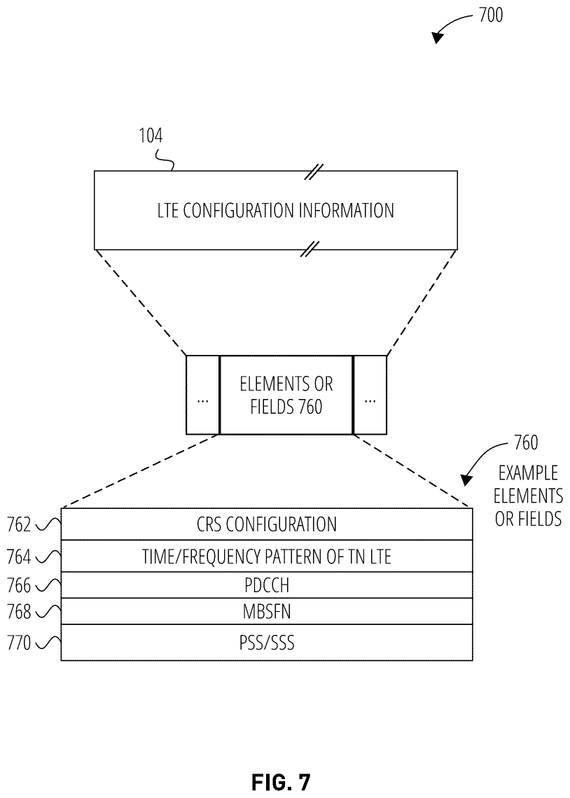

FIG. 7 shows example contents 700 of the LTE configuration information of FIG. 6. In the example shown in FIG. 7, LTE configuration information 104 includes elements/fields 760, including one or more of CRS configuration 762, the time/frequency pattern of terrestrial LTE 764, LTE PDCCH configuration 766, LTE MBSFN configuration 768, and/or LTE PSS/SSS configuration 770. In one example, the LTE PDCCH configuration 766 includes a Control Format Indicator (CFI) configuration, which specifies the number of orthogonal frequency division multiplexing (OFDM) symbols (e.g., 1, 2, or 3 OFDM symbols) in the time domain used by LTE PDCCH. Additionally, LTE PDCCH is a wideband signal and can occupy the entire carrier frequency (e.g., component carrier). Accordingly, it can be difficult to rate match around PDCCH. The NTN node 140 therefore may avoid using time-frequency resources reserved for LTE PDCCH if possible. In another example, the LTE MBSFN configuration 768 includes a MBSFN subframe configuration specifying the subframes used for MBSFN service. In some examples, the time/frequency pattern of terrestrial LTE 764 includes indication of resource elements that are reserved for various LTE signals/channels. In some other examples, the LTE PSS/SSS configuration 770 includes a periodicity of the LTE PSS/SSS.

Returning to FIG. 6, the NTN node 140 determines (shown at block 602) that there is potential conflict with a 4G LTE TN BS (such as BS 128) along the path of the NTN node 140. In some implementations, the NTN node 140 may request (shown at arrow 603) LTE configuration information 104 from the BS 128. For example, the NTN node 140 can transmit a message (such as a request message) to the BS 128 to request the LTE configuration information 104. Alternatively, or additionally, the NTN node 140 can request the LTE configuration information 104 from another NTN node (not shown), from the geostationary NTN node 170 or from the ground station 150.

In one example approach, the NTN node 140 does not request the LTE configuration information 104 from BS 128. Instead, the information is sent periodically or as needed from a GEO satellite or other network element.

In one example approach, the NTN node 140 is configured to predict its movement and to identify LTE base stations 128 that will be encountered on its predicted path. In one such example approach, the NTN node 140 predicts its movement based on known locations of the LTE base stations 128 and on ephemeris information for the NTN node 140. In one such example approach, the prediction is based on location and on whether there is overlap of coverage area (potential interference) between LTE and NTN cells. In one example approach, the locations include 4G LTE TN base station locations and NTN satellite positions. As noted above, in some example approaches, the NTN node 140 is configured to steer beams to avoid potential interference when possible.

In one example approach, the NTN node 140 obtains the LTE configuration information 104 when the NTN node 140 identifies the BS 128 as a source of potential conflict for the NTN node 140 as the NTN node 140 moves along its path. In one example, the conflict arises out of a potential intersection of 5G NTN coverage provided by the NTN node 140 with LTE coverage provided by the BS 128. In one such example approach, the NTN node 140 modifies the DSS configuration settings to mitigate interference by and to BS 128.

The NTN node 140 obtains the LTE configuration information 104 (shown at arrow 604) including one or more of CRS configuration, PDCCH configuration, MBSFN configuration, and/or PSS/SSS configuration, as shown in FIG. 7. In some implementations, the NTN node 140 obtains the LTE configuration information 104 via a message (such as a response message) from the BS 128. Alternatively, or additionally, the NTN node 140 may obtain the LTE configuration information 104 via a communication from its ground station 150 or another NTN node (such as a geostationary or HEO satellite).

The NTN node 140 determines (shown at block 606) whether to update DSS settings based on factors such as the LTE configuration information 104 and the time of the potential overlap of the coverage area of NTN node 140 with the coverage area of BS 128, as determined in block 602. In one example approach, the NTN node 140 updates DSS configuration for the UE 110 based on the received LTE configuration information and on expected LTE traffic and 5G NR traffic. In one approach, the NTN node 140 prioritizes LTE traffic from the terrestrial LTE base stations over the NR traffic. Accordingly, the satellite NR stations such as the NTN node 140 and their served NR UEs adjust their spectrum utilization to minimize interference to the terrestrial LTE base stations. The NTN node 140 then transfers (shown at arrow 608) the DSS configuration to the UE 110. In an example, the NTN node 140 may broadcast the DSS configuration via a SIB. In other examples, the NTN node 140 may transmit the DSS configuration via a RRC message. The UE 110 receives (shown at block 612) the DSS configuration and can use the DSS configuration for rate matching and proper reception of the NR PDCCH and/or NR physical downlink shared channel (PDSCH). In some examples, the DSS configuration may indicate that the NR PDCCH and/or NR PDSCH will be rate matched around the LTE CRS. Accordingly, the UE 110 will understand that resource elements reserved for LTE CRS are not used for NR PDCCH and/or NR PDSCH to properly decode these NR channels. In one example approach, if the NTN node 140 decides to update DSS settings of one or more UEs 110, the NTN node 140 communicates the DSS configuration to the one or more UEs 110 or to other network elements directly, or via other network elements. In one example approach, the NTN node 140 configures a DSS configuration on a per beam basis and transmits the DSS configurations to the appropriate UEs 110.

The NTN node 140 may coordinate its transmissions with transmissions of the terrestrial base station based on the DSS configuration. For example, the NTN node 140 may share (shown at arrow 614) scheduling information with the terrestrial BS 128 and synchronize its transmissions with a wireless channel of the terrestrial BS 128. NTN node 140 may also need to communicate scheduling information with the ground station 150 or with a different terrestrial BS 128 if NTN node 140 moves. The NTN node 140 may transmit (shown at arrow 616) an NR PDCCH with downlink control information (DCI) in accordance with the DSS configuration and scheduled resources. The NTN node 140 may also communicate (shown at arrow 618) downlink transmissions via an NR PDSCH that uses rate matching around resource elements reserved for CRS of the terrestrial LTE base station 128. In other examples, the NTN node 140 may puncture resource elements of the NR PDCCH and/or PDSCH that are reserved for CRS of the terrestrial LTE base station 128.

It is possible that one NTN node beam may overlap with multiple 4G LTE TN base stations. In one example approach, the NTN node adjusts the DSS configuration settings to accommodate multiple base stations. For example, the NTN node may need to avoid PDCCH regions (resource elements) for multiple LTE base stations, depending on whether interference from NTN to LTE or vice versa is significant. In addition, the NTN node may, in some examples, limit overlapping areas with the multiple base stations via beam steering.

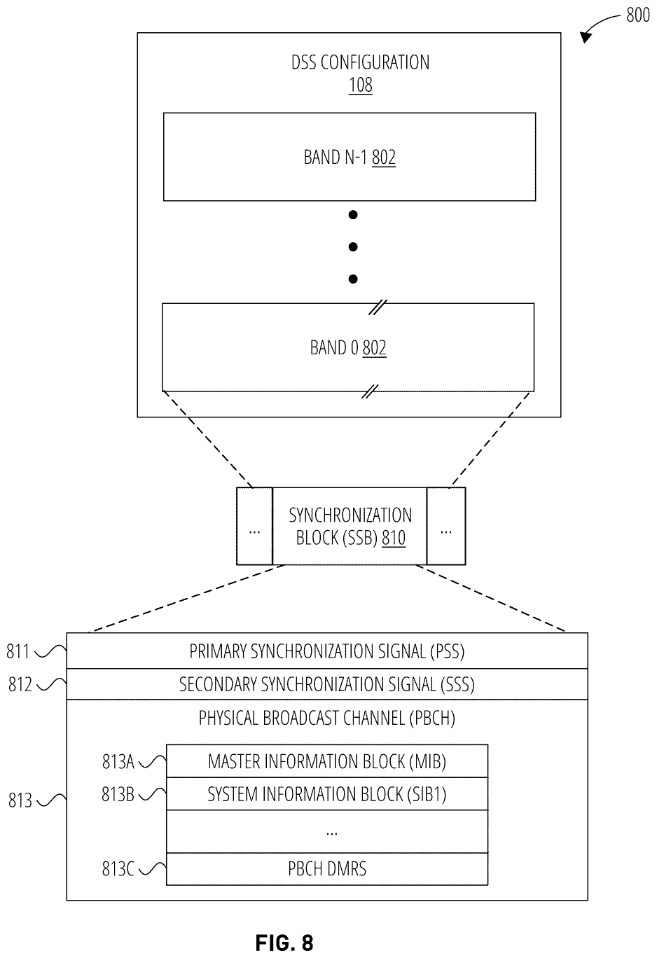

FIG. 8 shows an example DSS configuration 800 used in one example approach for transferring, to a UE, DSS configuration information regarding 5G and LTE communications to the UE. In the example shown in FIG. 8, DSS configuration 108 includes configuration information for N frequency bands 802 (BAND 0, . . . , BAND N-1). The configuration information for each band may be included in an NR synchronization signal block (SSB) 810, which is the broadcast signal used by NR devices to detect NR cells.

In one example approach, each SSB 810 is a one-shot transmission with a default 20 millisecond cycle (periodicity) when using 15 kHz Subcarrier Spacing (SCS). It is noted that the SSB may be transmitted using other periodicities and subcarrier spacings. The SSB 810 is used by UEs for initial access to a 5G NR cell. The SSB 810 can be transmitted in different beam directions to improve coverage. To improve the detection performance, the SSB may be transmitted without collision with LTE signals/channels.

In one example approach, SSB 810 occupies 20 RBs and 4 OFDM symbols. One OFDM symbol is used for primary synchronization signal (PSS) 811, one OFDM symbol is used for secondary synchronization signal (SSS) 812, and the remaining two OFDM symbols are used for the Physical Broadcast Channel (PBCH) 813. SSB 810 therefore spans four OFDM symbols in the time domain and 240 subcarriers in the frequency domain.

To avoid collisions with LTE CRS transmission, in one such example approach, SSB is transmitted in an LTE Multicast-Broadcast Single Frequency Network (MBSFN) subframe, which only contains LTE CRS in the control region of the LTE PDCCH (e.g., first one or two OFDM symbols in the MBSFN subframe). In one example approach, the DSS configuration allocates the whole subframe (except for the LTE PDCCH region) for NR transmission. In one example approach, DSS configuration 108 includes one or more CRS configurations, the time/frequency pattern of terrestrial LTE base station, LTE PDCCH configuration, LTE MBSFN configuration, and LTE PSS/SSS configuration.

In one example approach, PBCH 813 includes a master information block (MIB) 813A, one or more system information blocks (SIB1 . . . SIBN) 813B, and a PBCH demodulation reference signal (DMRS) 813C. In one example approach, SIB1 813B is used in the MBSFN to describe for the UE 110 scheduling for all relevant system information. In some example approaches, SIB1 may also provide further information such subcarrier spacing (the information element called subcarrierSpacing set to, e.g., kHz), the signal bandwidth (locationAndBandwith 12925—equal to 48 physical resource blocks (PRB)), and the number of transmitted SSB beams. In one example, PBCH DMRS 813C may be used to rate match. In some implementations, an SIB message may be transmitted in response to a request from a UE or network element. Alternatively, or additionally, the SIB message may be broadcast periodically to all UEs within a coverage area of the NTN node using, for instance, SSB 810.

In the DSS configuration transmission approach via SSB 810 discussed above, the DSS configuration becomes effective or active on receipt. In another example approach, the DSS configuration 108 is transmitted to UEs 110 prior to becoming effective or active. As such, in some examples, the DSS configuration 108 also includes or is associated with timing information detailing when the DSS configuration becomes active or how long the DSS configuration is active. In some example approaches, the timing information is based on predicted movement of the NTN node 140 and details when (in terms of, for example, a subframe number (SFN), slot number, starting slot/ending slot, or the number of slots) the DSS configuration is active or valid.

In one example approach, the NTN node 140 transmits a radio resource control (RRC) message to one or more UEs. The RRC message is specific to a UE 110 configured to receive the RRC message. In one example approach, the RRC message includes timing information used by the UE to activate the DSS configuration at a particular frame, subframe, or slot, or for a number of frames, subframes, or slots. Generally, a DSS configuration may be active or valid for multiple frames (depending on the movement of the NTN node 140). Typically, a DSS configuration should be active for several minutes, however, if not longer.

In one example approach, the NTN node 140 may determine UE specific DSS configurations based on UE position or may account for the effects of multiple overlapping LTE base stations 128, as detailed further below.

In one example approach, DSS configuration 108 may include timing information, geographical information, UE identification information, or any combination thereof. Examples of timing information may include a start time, an end time, or a duration. In some implementations, the timing information may be indicated in relation to a frame indicator (such as a subframe number or slot number). The timing information may cause a UE 110 to begin using the DSS configuration at the start time and stop using the DSS configuration at the end time. The timing information may be related to a time during which the coverage area of the NTN node 140 (e.g., 5G NR coverage) will overlap the coverage area of the terrestrial BS 128 (e.g., 4G LTE coverage). In some implementations, the DSS configuration may include geographical information to limit which UEs should use the DSS configuration. For example, geographical information indicating an area based on longitude, latitude, and distance or radius from the center of the Earth may be used to indicate a satellite position. Alternatively, or additionally, the geographical information may indicate an area based on a description of boundaries.

In one example approach, each UE 110 may determine its location using a global navigation satellite system (GNSS) or other technique. Examples of a GNSS include a Global Positioning System (GPS), GLONASS, BeiDou Navigation Satellite System, India regional navigation satellite system (NAVIC), and Galileo, among other examples. In one such example approach, each DSS configuration is structured to be used by any UEs that are located within the area indicated by the geographical information given in the DSS configuration. In some implementations, the DSS configuration may include identification information to identify one or more UEs that should use the DSS configuration. Thus, in some implementations, the DSS configuration may be specific to selected UEs and yet broadcast to some or all nearby UEs.

In one example approach, location based DSS configuration is broadcasted via SIB messages. In one such example approach, the SIB message includes LTE frequency, LTE channels, bandwidth, MBSFN subframe configuration, and the number and location of LTE CRS ports. The SIB message further includes the GNSS position (latitude and longitude) where the DSS configuration is applicable. The GNSS information included in the SIB message may also include radius from the center of Earth, or it may identify an area via metes and bounds (i.e., boundary information).

In one such example approach, each UE 110 adjusts its current DSS configuration based on its location. For instance, each UE 110 may access local Global Navigation Satellite System (GNSS) position information. When the location of the UE 110 changes, the UE 110 checks to see if it is in a region associated with a different DSS configuration. If so, the UE 110 updates DSS configuration to the DSS configuration corresponding to that region, as indicated in an earlier-received SIB message. In addition, in some example approaches, each UE 110 can request an SIB message containing new DSS configuration settings when needed.

In some aspects, the NTN node 140 determines whether to perform rate matching based on CRS configurations of one or more terrestrial base stations. Rate matching is a technique in which the NTN node transmits downlink signals/channels that do not use time-frequency resources that would otherwise interfere with the reference signals or other high-priority channels (such as a PDCCH). In other words, the NTN node transmits downlink signals/channels that are rate matched around the reference signals or other high priority channels of the other RAT. A rate matching algorithm may utilize an MBSFN configuration, frequency shifting based on physical cell identity (PCI), or other information to identify time-frequency resources (or resource elements) the NTN node should not use. While rate matching can mitigate against interference between the 5G NR signals and the LTE signals, rate matching may increase overhead or reduce throughput. Thus, the NTN node 140 may determine whether to perform rate matching based on when the NTN signals are expected to interfere with the LTE signals/channels of a terrestrial base station.

In one example approach, the NTN node 140 rate matches against LTE CRS ports from multiple base stations 128. Note that the LTE base station CRS port(s) depends on LTE base station transmission (TX) antennas and on physical cell identity (PCI). For example, a CRS configuration might describe a reference signal using 1, 2, or 4 antenna ports.

In some implementations, the NTN node 140 may perform rate matching based on an aggregation of multiple CRS configurations (such as when CRS configurations have overlapping PCI). In one such example approach, LTE CRS is transmitted in every subframe (slot) across the entire bandwidth. The number of antenna ports for transmitting CRS may be configured as 1, 2, or 4 antenna ports. The location (time-frequency resource or resource element) of the CRS depends on the PCI. The time domain (symbol) index is fixed but the frequency domain (subcarrier) index is dependent on the PCI. The CRS from one cell (one PCI) may, for instance, be transmitted at the same location (same time-frequency resource) as the CRS from another cell (another PCI).

In some implementations, the NTN node may disable rate matching when its signals are not expected to interfere with the LTE CRS of the terrestrial base station based on the DSS information. Rate matching, however, can mitigate NR interference with LTE CRS and LTE CRS interfering with NR UE reception and the impact to overhead and throughput may be acceptable to reduce interference. Rate matching against the LTE CRS tones from even a large number of LTE base stations 128 is still possible due to CRS overlapping from LTE base stations 128 since the frequency shift of CRS is based on PCI mod 6. That is, the CRS from one LTE base station (with PCI1) may be transmitted on the same resource elements as the CRS from another LTE base station (with PCI2) when PCI1 mod 6=PCI2 mod 6.

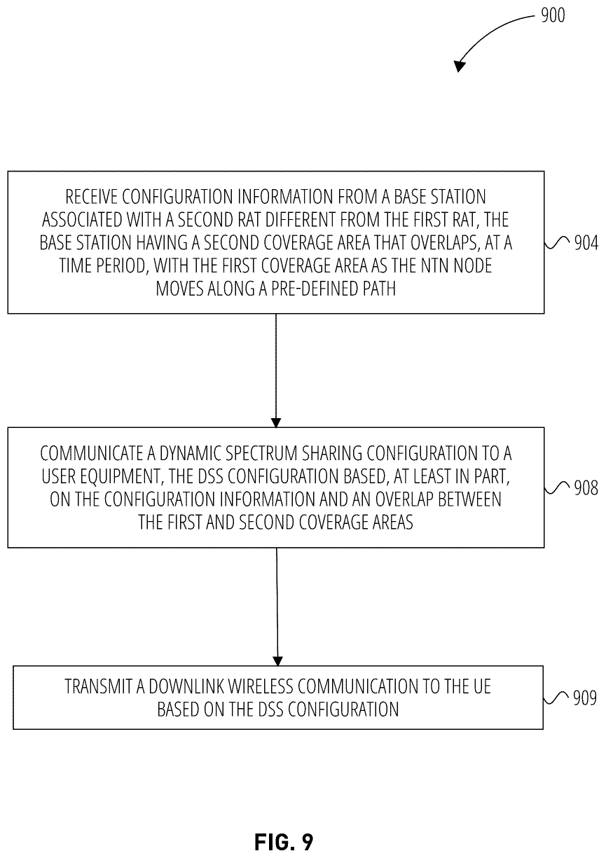

FIG. 9 shows a flow chart illustrating an example technique used by an NTN node to share spectrum with an LTE base station. For example, the operations 900 of FIG. 9 can be performed by a non-stationary NTN node (such as NTN node 140 described with reference to any of FIG. 1-4 or 6). In block 904, the NTN node receives configuration information (104) from a base station (128) associated with a second RAT different from the first RAT. In some implementations, the second RAT is LTE and the configuration information is LTE configuration information 104 described with reference to any of FIG. 1-4, 6, or 7. The base station has a second coverage area that overlaps, at a time period, with a first coverage area of the NTN node (140) as the NTN node moves along a pre-defined path. In block 908, the NTN node communicates a dynamic spectrum sharing (DSS) configuration to a UE, the DSS configuration based, at least in part, on the configuration information and the overlap between the first and second coverage areas. Examples of block 908 include the communication of DSS configuration 108 as described with reference to any of FIG. 1-4, 6, or 8. In block 909, the NTN node transmits a downlink wireless communication to the UE based on the DSS configuration.

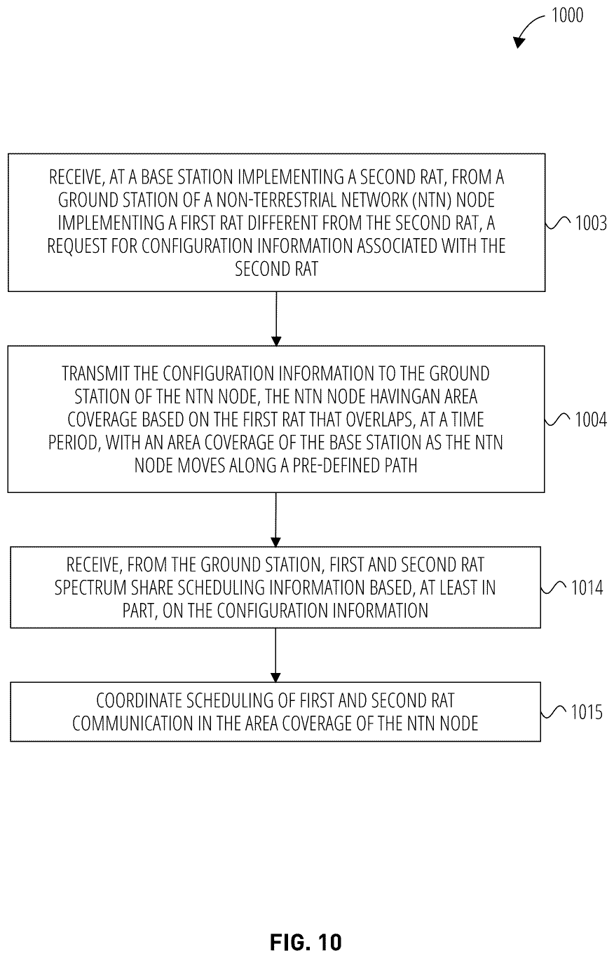

FIG. 10 shows a flow chart illustrating an example technique used by an LTE base station to share spectrum with an NTN node. For example, the operations 1000 of FIG. 10 can be performed by an LTE base station (such as any of the BSs 128, 128A, or 128B described with reference to FIG. 1-4 and FIG. 6) to coordinate DSS with a non-stationary NTN node (140). In block 1003, the LTE base station receives, from a ground station of an NTN node implementing a first RAT different from the second RAT, a request for configuration information associated with the block 1003. An example of the operations in block 1003 is described as a request (shown at arrow 603) with reference to FIG. 6.

At block 1004, the LTE base station transmits the configuration information to the ground station 150 of the NTN node 140, the NTN node having a coverage area based on the first RAT that overlaps, at a time period, with a coverage area of the base station as the NTN node moves along a pre-defined path. An example of the operations in block 1004 is described as a communication (shown at arrow 604) from the BS 128 to the NTN node 140 with reference to FIG. 6.

In block 1014, the LTE base station receives, from the ground station, first and second RAT spectrum share scheduling information based, at least in part, on the configuration information. An example of the operations in block 1014 is described as a communication (shown at arrow 614) from the NTN node 140 to the BS 128 with reference to FIG. 6. In block 1015, the LTE base station coordinates scheduling of first and second RAT communication in the coverage area of the NTN node.

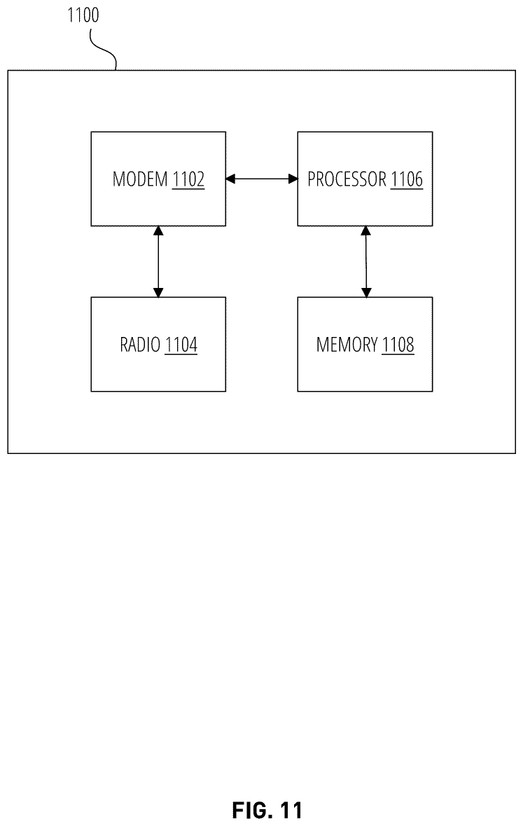

FIG. 11 shows a block diagram of an example wireless communication apparatus. In the example shown in FIG. 11, wireless communication apparatus 1100 can be an example of a device for use in a UE, such as the UE 110 described with reference to any of the Figures herein. The wireless communication apparatus 1100 is capable of transmitting (or outputting for transmission) and receiving wireless communications.

The wireless communication apparatus 1100 can be, or can include, a chip, system on chip (SoC), chipset, package, or device. The term “system-on-chip” (SoC) is used herein to refer to a set of interconnected electronic circuits typically, but not exclusively, including one or more processors, a memory, and a communication interface. The SoC may include a variety of different types of processors and processor cores, such as a general-purpose processor, a central processing unit (CPU), a digital signal processor (DSP), a graphics processing unit (GPU), an accelerated processing unit (APU), a sub-system processor, an auxiliary processor, a single-core processor, and a multicore processor. The SoC may further include other hardware and hardware combinations, such as a field programmable gate array (FPGA), a configuration and status register (CSR), an application-specific integrated circuit (ASIC), other programmable logic device, discrete gate logic, transistor logic, registers, performance monitoring hardware, watchdog hardware, counters, and time references. SoCs may be integrated circuits (ICs) configured such that the components of the IC reside on the same substrate, such as a single piece of semiconductor material (such as, for example, silicon).

The term “system in a package” (SIP) is used herein to refer to a single module or package that may contain multiple resources, computational units, cores and/or processors on two or more IC chips, substrates, or SoCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP also may include multiple independent SoCs coupled together via high-speed communication circuitry and packaged in close proximity, such as on a single motherboard or in a single mobile communication device. The proximity of the SoCs facilitates high speed communications and the sharing of memory and resources.

The term “multicore processor” is used herein to refer to a single IC chip or chip package that contains two or more independent processing cores (for example a CPU core, IP core, GPU core, among other examples) configured to read and execute program instructions. An SoC may include multiple multicore processors, and each processor in an SoC may be referred to as a core. The term “multiprocessor” may be used herein to refer to a system or device that includes two or more processing units configured to read and execute program instructions.

The wireless communication apparatus 1100 may include one or more modems 1102. In some implementations, modems 1102 may include a WWAN modem (for example, a 3GPP 4G LTE or 5G compliant modem). In some implementations, the wireless communication apparatus 1100 also includes one or more radios 1104 (collectively “the radio 1104”). In some implementations, the wireless communication apparatus 1100 further includes one or more processors, processing blocks or processing elements (collectively “the processor 1106”) and one or more memory blocks or elements (collectively “the memory 1108”).

The modem 1102 can include an intelligent hardware block or device such as, for example, an application-specific integrated circuit (ASIC) among other possibilities. Modem 1102 is configured to implement a PHY layer. For example, modem 1102 is configured to modulate packets and to output the modulated packets to the radio 1104 for transmission over the wireless medium. The modem 1102 is similarly configured to obtain modulated packets received by the radio 1104 and to demodulate the packets to provide demodulated packets. In addition to a modulator and a demodulator, modem 1102 may further include digital signal processing (DSP) circuitry, automatic gain control (AGC), a coder, a decoder, a multiplexer and a demultiplexer. For example, while in a transmission mode, data obtained from processor 1106 is provided to a coder, which encodes the data to provide encoded bits. The encoded bits are mapped to points in a modulation constellation (using a selected MCS) to provide modulated symbols. The modulated symbols may be mapped to a number of spatial streams or a number of space-time streams. The modulated symbols in the respective spatial or space-time streams may be multiplexed, transformed via an inverse fast Fourier transform (IFFT) block, and subsequently provided to the DSP circuitry for TX windowing and filtering. The digital signals may be provided to a digital-to-analog converter (DAC). The resultant analog signals may be provided to a frequency upconverter, and ultimately, the radio 1104. In implementations involving beamforming, the modulated symbols in the respective spatial streams are precoded via a steering matrix prior to their provision to the IFFT block.

While in a reception mode, digital signals received from the radio 1104 are provided to the DSP circuitry, which is configured to acquire a received signal, for example, by detecting the presence of the signal and estimating the initial timing and frequency offsets. The DSP circuitry is further configured to digitally condition the digital signals, for example, using channel (narrowband) filtering, analog impairment conditioning (such as correcting for I/Q imbalance), and applying digital gain to obtain a narrowband signal. The output of the DSP circuitry may be fed to the AGC, which is configured to use information extracted from the digital signals, for example, in one or more received training fields, to determine an appropriate gain. The output of the DSP circuitry also is coupled with the demodulator, which is configured to extract modulated symbols from the signal and, for example, compute the logarithm likelihood ratios (LLRs) for each bit position of each subcarrier in each spatial stream. The demodulator is coupled with the decoder, which may be configured to process the LLRs to provide decoded bits. The decoded bits from the spatial streams are fed to the demultiplexer for demultiplexing. The demultiplexed bits may be descrambled and provided to the processor 1106 for processing, evaluation, or interpretation.

The radio 1104 includes at least one radio frequency (RF) transmitter (or “transmitter chain”) and at least one RF receiver (or “receiver chain”), which may be combined into one or more transceivers. For example, the RF transmitters and receivers may include various DSP circuitry including at least one power amplifier (PA) and at least one low-noise amplifier (LNA), respectively. The RF transmitters and receivers may, in turn, be coupled to one or more antennas. For example, in some implementations, the wireless communication apparatus 1100 can include, or be coupled with, multiple transmit antennas (each with a corresponding transmit chain) and multiple receive antennas (each with a corresponding receive chain). The symbols output from modem 1102 are provided to the radio 1104, which transmits the symbols via the coupled antennas. Similarly, symbols received via the antennas are obtained by radio 1104, which provides the symbols to modem 1102.

The processor 1106 can include an intelligent hardware block or device such as, for example, a processing core, a processing block, a central processing unit (CPU), a microprocessor, a microcontroller, a digital signal processor (DSP), an application-specific integrated circuit (ASIC), a programmable logic device (PLD) such as a field programmable gate array (FPGA), discrete gate or transistor logic, discrete hardware components, or any combination thereof designed to perform the functions described herein. Processor 1106 processes information received through radio 1104 and the modem 1102, and processes information to be output through the modem 1102 and the radio 1104 for transmission through the wireless medium. In some implementations, processor 1106 may control the modem 1102 to cause the modem to perform various operations described throughout.

Memory 1108 can include tangible storage media such as random-access memory (RAM) or read-only memory (ROM), or combinations thereof. The memory 1108 also can store non-transitory processor-or computer-executable software (SW) code containing instructions that, when executed by the processor 1106, cause the processor to perform various operations described herein for wireless communication. For example, various functions of components disclosed herein, or various blocks or steps of a method, operation, process, or algorithm disclosed herein, can be implemented as one or more modules of one or more computer programs.

FIG. 1 to FIG. 11 and the operations described herein are examples meant to aid in understanding example implementations and should not be used to limit the potential implementations or limit the scope of the claims. Some implementations may perform additional operations, fewer operations, operations in parallel or in a different order, and some operations differently.

As noted above, an NTN node may mitigate interference with terrestrial base stations that the NTN node may encounter as the NTN node moves along a path that encounters the terrestrial base stations. Furthermore, the NTN node can take advantage of spectrum sharing techniques. In some aspects, the NTN can coordinate the DSS configurations of various beams based on when and where the beams will create coverage areas that overlap terrestrial base stations.

The foregoing disclosure provides illustration and description but is not intended to be exhaustive or to limit the aspects to the precise form disclosed. Modifications and variations may be made in light of the above disclosure or may be acquired from practice of the aspects. While the aspects of the disclosure have been described in terms of numerous examples, any combination of aspects from any of the examples is also within the scope of the disclosure. The examples in this disclosure are provided for pedagogical purposes. Alternatively, or in addition to the other examples described herein, examples include any combination of the following implementation options (enumerated as clauses for clarity).

### CLAUSES

Clause 1. A method for wireless communication by a non-terrestrial network (NTN) node associated with a first radio access technology (RAT), the NTN node having a first coverage area, the method including receiving configuration information from a base station associated with a second RAT different from the first RAT, the base station having a second coverage area that overlaps, at a time period, with the first coverage area as the NTN node moves along a pre-defined path; communicating a dynamic spectrum sharing (DSS) configuration to a UE, the DSS configuration based, at least in part, on the configuration information and an overlap between the first and second coverage areas; and transmitting a downlink wireless communication to the UE based on the DSS configuration.

Clause 2. The method of clause 1, where the communicating includes: establishing different DSS configurations for each of a plurality of beams of the NTN node, at least one of the different DSS configurations reflecting beamforming of a first beam of the plurality of beams to reduce overlap of the first beam with the first coverage area of the base station.

Clause 3. The method of clause 1, further including: dynamically adjusting the DSS configuration to prioritize terrestrial base station communication.

Clause 4. The method of clause 1, where the communicating includes scheduling, at the NTN node and in conjunction with the base station, a portion of spectrum to be allocated to the NTN node.

Clause 5. The method of clause 1, where the communicating includes scheduling at a ground station of the NTN node and in conjunction with the base station, a portion of spectrum allocated to first RAT communication by the NTN node.

Clause 6. The method of any one of clauses 4 and 5, where the scheduling includes providing scheduling information for each slot and resource block.

Clause 7. The method of any one of clauses 1-6, where the receiving includes receiving the configuration information from another NTN node.

Clause 8. The method of any one of clauses 1-7, where the communicating includes determining, on a per beam basis, when the first coverage area of the NTN node overlaps with the second coverage area of the base station.

Clause 9. The method of any one of clauses 1-8, where the communicating includes communicating the DSS configuration to the UE via at least one of a system information block (SIB) message or a radio resource control (RRC) message.

Clause 10. The method of any one of clauses 1-9, the method further including transmitting a request message requesting the configuration information.

Clause 11. The method of any one of clauses 1-10, where the configuration information includes at least one of a cell reference signal (CRS) configuration; a physical downlink control channel (PDCCH) configuration; a multicast-broadcast single frequency network (MBSFN) configuration; a primary synchronization signal (PSS) configuration; or a secondary synchronization signal (SSS) configuration.

Clause 12. The method of any one of clauses 1-11, where the NTN node includes a ground station and where the method further includes sharing scheduling information between the ground station and the base station.

Clause 13. The method of any one of clauses 1-12, where the communicating includes transferring location based DSS configuration to the UE via a system information block (SIB) message.

Clause 14. The method of any one of clauses 1-13, where the communicating includes transferring timing-related information associated with the DSS configuration to the UE via a radio resource control (RRC) message, the timing-related information indicating approximately the time period of the overlap between the first and second coverage areas.

Clause 15. The method of clause 14, where the timing-related information indicates a beginning time for the DSS configuration to become valid.

Clause 16. The method of clauses 14 or 15, where the timing-related information includes one of a duration or an ending time associated with the DSS configuration.

Clause 17. The method of any one of clauses 14-16, where the DSS configuration includes geographical information associated with the DSS configuration such that the DSS configuration is applicable to the UE within an area associated with the geographical information.

Clause 18. The method of any one of clauses 1-17, where the DSS configuration includes timing and frequency information associated with a cell reference signal (CRS) of the base station, the method further including: enabling rate matching when transmissions from the NTN node may cause interference with communication by the base station.

Clause 19. The method of any one of clauses 1-18, where the DSS configuration includes timing and frequency information associated with a cell reference signal (CRS) of the base station, the method further including: enabling rate matching based on interference to second RAT transmissions due to first RAT transmissions by the NTN node.

Clause 20. The method of any one of clauses 1-19, further including: predicting when the first coverage area will overlap with two or more second coverage areas, each second coverage area associated with a terrestrial network (TN) node of the second RAT; aggregating DSS information associated with the TN nodes (120); and modifying the DSS configuration based on the aggregated DSS information.

Clause 21. The method of clause 20, where the aggregated DSS information includes cell reference signal (CRS) configurations associated with the TN nodes (120), the CRS configurations for each TN node including CRS port information for the respective TN node, and wherein the modifying the DSS configuration includes rate matching around the CRS ports from at least two of the two or more TN nodes (120) when the two TN nodes have overlapping CRS configurations.

Clause 22. The method of any of clauses 1-21, where the NTN node includes a ground station, the method further comprising allocating, at the ground station, a portion of spectrum from the second RAT to the NTN node based, at least in part, on expected movement of the NTN node relative to the base station.

Clause 23. The method of any of clauses 1-22, further including: identifying a time when coverage area of the base station will begin to overlap with coverage area of the NTN node; and where the communicating includes adding timing information to the DSS configuration notifying the UE of the time when the DSS configuration is activated.

Clause 24. The method of any one of clauses 1-23, where the first RAT includes a New Radio (NR) RAT and the second RAT includes a long term evolution (LTE) RAT.

Clause 25. A non-terrestrial network (NTN) node, including: a processor; and memory for storing instructions which, when executed by the processor, implement any one of method Clauses 1-24.

Clause 26. A method for wireless communication by a base station associated with a second radio access technology (RAT), the method including: receiving, at the base station, from a ground station of a non-terrestrial network (NTN) node implementing a first RAT different from the second RAT, a request for configuration information associated with the second RAT; transmitting the configuration information to the ground station of the NTN node, the NTN node having an coverage area based on the first RAT that overlaps, at a time period, with a coverage area of the base station as the NTN node moves along a pre-defined path; and receiving, from the ground station, first and second RAT spectrum share scheduling information based, at least in part, on the configuration information and the overlap between the first and second coverage areas.

Clause 27. The method of clause 26, wherein the method further comprises coordinating scheduling of first and second RAT communication in the coverage area of the NTN node.

Clause 28. The method of any one of clauses 26-27, wherein the first RAT includes a New Radio (NR) RAT and the second RAT includes a long term evolution (LTE) RAT.

Clause 29. A base station, including: a processor; and memory for storing instructions which, when executed by the processor, implement any one of the method clauses 26-28.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.”

Some aspects are described herein in connection with thresholds. As used herein, satisfying a threshold may refer to a value being greater than the threshold, greater than or equal to the threshold, less than the threshold, less than or equal to the threshold, equal to the threshold, not equal to the threshold, or the like.

As used herein, a phrase referring to a list of items separated by “or” refers to any combination of those items, including single members. For example, “a, b, or c” is intended to cover the possibilities of: a only, b only, c only, a combination of a and b, a combination of a and c, a combination of b and c, and a combination of a and b and c.

In this disclosure, an expression of “X/Y” may include meaning of any of the following: “X or Y” or “X and Y” or “X and/or Y.” An expression of “(A) B” or “B (A)” may include concept of “only B.” An expression of “(A) B” or “B (A)” may include the concept of “A+B” or “B+A.”

The various illustrative components, logic, logical blocks, modules, circuits, operations, and algorithm processes described in connection with the implementations disclosed herein may be implemented as electronic hardware, firmware, software, or combinations of hardware, firmware, or software, including the structures disclosed in this specification and the structural equivalents thereof. The interchangeability of hardware, firmware and software has been described, in terms of functionality, and illustrated in the various illustrative components, blocks, modules, circuits and processes described above. Whether such functionality is implemented in hardware, firmware or software depends upon the application and design constraints imposed on the overall system.

The hardware and data processing apparatus used to implement the various illustrative components, logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, or any conventional processor, controller, microcontroller, or state machine. A processor also may be implemented as a combination of computing devices, for example, a combination of a DSP and a microprocessor, multiple microprocessors, one or more microprocessors in conjunction with a DSP core, or any other such configuration. In some implementations, particular processes, operations, and methods may be performed by circuitry that is specific to a given function.

As described above, in some aspects implementations of the subject matter described in this specification can be implemented as software. For example, various functions of components disclosed herein, or various blocks or steps of a method, operation, process, or algorithm disclosed herein can be implemented as one or more modules of one or more computer programs. Such computer programs can include non-transitory processor-or computer-executable instructions encoded on one or more tangible processor-or computer-readable storage media for execution by, or to control the operation of, data processing apparatus including the components of the devices described herein. By way of example, and not limitation, such storage media may include RAM, ROM, EEPROM, CD-ROM or other optical disk storage, magnetic disk storage or other magnetic storage devices, or any other medium that may be used to store program code in the form of instructions or data structures. Combinations of the above should also be included within the scope of storage media.

As used herein, the terms “user equipment”, “wireless communication device”, “mobile communication device”, “communication device”, or “mobile device” refer to any one or all of cellular telephones, smartphones, portable computing devices, personal or mobile multi-media players, laptop computers, tablet computers, smartbooks, Internet-of-Things (IoT) devices, palm-top computers, wireless electronic mail receivers, multimedia Internet enabled cellular telephones, wireless gaming controllers, display sub-systems, driver assistance systems, vehicle controllers, vehicle system controllers, vehicle communication system, infotainment systems, vehicle telematics systems or subsystems, vehicle display systems or subsystems, vehicle data controllers or routers, and similar electronic devices which include a programmable processor and memory and circuitry configured to perform operations as described herein.

As used herein, the terms “SIM,” “SIM card,” and “subscriber identification module” are used interchangeably to refer to a memory that may be an integrated circuit or embedded into a removable card, and that stores an International Mobile Subscriber Identity (IMSI), related key, or other information used to identify or authenticate a mobile communication device on a network and enable a communication service with the network. Because the information stored in a SIM enables the mobile communication device to establish a communication link for a particular communication service with a particular network, the term “subscription” is used herein as a shorthand reference to refer to the communication service associated with and enabled by the information stored in a particular SIM as the SIM and the communication network, as well as the services and subscriptions supported by that network, correlate to one another. A SIM used in different examples may contain user account information, an international mobile subscriber identity (IMSI), a set of SIM application toolkit (SAT) commands, and storage space for phone book contacts. A SIM card may further store home identifiers (such as, a System Identification Number (SID)/Network Identification Number (NID) pair, a Home Public Land Mobile Number (HPLMN) code, among other examples) to indicate the SIM card network operator provider. An Integrated Circuit Card Identity (ICCID) SIM serial number may be printed on the SIM card for identification. However, a SIM may be implemented within a portion of memory of the mobile communication device, and thus need not be a separate or removable circuit, chip, or card.

Unless defined otherwise, technical and scientific terms used herein have the same meaning as is commonly understood by one of ordinary skill in the art to which this specification belongs. The terms “first,” “second,” and the like, as used herein do not denote any order, quantity, or importance, but rather are used to distinguish one element from another. The use of terms “including,” “comprising” or “having” and variations thereof herein are meant to encompass the items listed thereafter and equivalents thereof as well as additional items. The terms “connected” and “coupled” are not restricted to physical or mechanical connections or couplings and can include electrical connections or couplings, whether direct or indirect. Furthermore, terms “circuit” and “circuitry” and “control unit” may include either a single component or a plurality of components, which are either active and/or passive and are connected or otherwise coupled together to provide the described function. In addition, the term operationally coupled as used herein includes wired coupling, wireless coupling, electrical coupling, magnetic coupling, radio communication, software based communication, or combinations thereof.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and the described program components and systems can be integrated together in a single software product or packaged into multiple software products. Additionally, other implementations are within the scope of the following claims. In some cases, the actions recited in the claims can be performed in a different order and still achieve desirable results.

1. A method for wireless communication by a non-terrestrial network (NTN) node, the method comprising:
operating a first radio access technology (RAT) in a first coverage area;
obtaining configuration information associated with a terrestrial network (TN) base station operating a second RAT in a second coverage area that overlaps, at a time period, with the first coverage area as the NTN node moves along a pre-defined path;
communicating, to a user equipment (UE), a dynamic spectrum sharing (DSS) configuration based on the configuration information and the time period when the first coverage area overlaps with the second coverage area; and
transmitting, to the UE, a downlink wireless communication based on the DSS configuration.

2. The method of claim 1, further comprising:
establishing different DSS configurations for each of a plurality of beams of the NTN node, at least one of the different DSS configurations reflecting beamforming of a first beam of the plurality of beams to reduce overlap of the first beam with the second coverage area of the TN base station.

3. The method of claim 1, further comprising:
scheduling, by the NTN node and in conjunction with the TN base station, a portion of spectrum to be allocated to the NTN node and the first RAT during the time period.

4. The method of claim 1, further comprising:
dynamically adjusting the DSS configuration to prioritize spectrum allocation for the second RAT of the TN base station.

5. The method of claim 1, wherein the communicating includes determining, on a per beam basis, when the first coverage area of the NTN node overlaps with the second coverage area of the TN base station.

6. The method of claim 1, wherein the communicating includes communicating, prior to the time period, the DSS configuration to the UE via at least one of a system information block (SIB) message or a radio resource control (RRC) message.

7. The method of claim 1, wherein the configuration information includes at least one of:
a cell reference signal (CRS) configuration;
a physical downlink control channel (PDCCH) configuration;
a multicast-broadcast single frequency network (MBSFN) configuration;
a primary synchronization signal (PSS) configuration; or
a secondary synchronization signal (SSS) configuration.

8. The method of claim 1, wherein the NTN node includes a ground station, the method further comprising sharing scheduling information between the ground station and the TN base station.

9. The method of claim 1, wherein the communicating includes transmitting a location based DSS configuration, and wherein the location based DSS configuration includes geographical information that indicates an area in which the location based DSS configuration is applicable.

10. The method of claim 1, wherein the communicating includes transmitting timing information associated with the DSS configuration, and wherein the timing information indicates at least one of:
approximately the time period of the overlap between the first and second coverage areas;
a beginning time for the DSS configuration to become valid;
a duration for the DSS configuration, wherein the duration is associated with the time period of the overlap; or
an ending time for the DSS configuration.

11. The method of claim 1, wherein the DSS configuration includes timing and frequency information associated with a cell reference signal (CRS) of the TN base station, the method further comprising:
enabling rate matching when first RAT transmissions from the NTN node are expected to cause interference with second RAT communication of the TN base station.

12. The method of claim 1, further comprising:
obtaining configuration information associated with multiple TN nodes operating the second RAT in corresponding coverage areas that overlap the first coverage area at corresponding time periods; and
modifying the DSS configuration based on the configuration information associated with the multiple TN nodes.

13. (canceled)

14. A method for wireless communication by a base station associated with a second radio access technology (RAT), the method comprising:
receiving, at the base station, from a ground station of a non-terrestrial network (NTN) node implementing a first RAT different from the second RAT, a request for configuration information associated with the second RAT;
transmitting the configuration information to the ground station of the NTN node, the NTN node having a first coverage area that overlaps, at a time period, with a second coverage area of the base station as the NTN node moves along a pre-defined path; and
receiving, from the ground station, first and second RAT spectrum sharing information based, at least in part, on the configuration information and the overlap between the first and second coverage areas.

15. The method of claim 14, further comprising:
coordinating scheduling of first and second RAT communication in the first coverage area of the NTN node, wherein the first RAT includes a new radio (NR) RAT and the second RAT includes a long-term evolution (LTE) RAT.

16. (canceled)

17. An apparatus, comprising:
a communication unit; and
a processing system configured to control the communication unit to:
operate a first radio access technology (RAT) in a first coverage area;
obtain configuration information associated with a terrestrial network (TN) base station operating a second RAT in a second coverage area that overlaps, at a time period, with the first coverage area as the NTN node moves along a pre-defined path;
communicate, to a user equipment (UE), a dynamic spectrum sharing (DSS) configuration based on the configuration information and the time period when the first coverage area overlaps with the second coverage area; and
transmit, to the UE, a downlink wireless communication based on the DSS configuration.

18. The apparatus of claim 17, wherein the processing system is further configured to control the communication unit to:
establish different DSS configurations for each of a plurality of beams of the NTN node, at least one of the different DSS configurations reflecting beamforming of a first beam of the plurality of beams to reduce overlap of the first beam with the second coverage area of the TN base station.

19. The apparatus of claim 17, wherein the processing system is further configured to control the communication unit to:
schedule, by the NTN node and in conjunction with the TN base station, a portion of spectrum to be allocated to the NTN node and the first RAT during the time period.

20. The apparatus of claim 17, wherein the processing system is further configured to control the communication unit to:
dynamically adjust the DSS configuration to prioritize spectrum allocation for the second RAT of the TN base station.

21. The apparatus of claim 17, wherein the processing system is further configured to control the communication unit to:
determine, on a per beam basis, when the first coverage area of the NTN node overlaps with the second coverage area of the TN base station.

22. The apparatus of claim 17, wherein the processing system is further configured to control the communication unit to:
communicate, prior to the time period, the DSS configuration to the UE via at least one of a system information block (SIB) message or a radio resource control (RRC) message.
